(19) United States
(12) Patent Application Publication
(10) Pub. No.: US 2023/0014165 A1
(43) Pub. Date: Jan. 19, 2023

(54) ELECTRICAL TRACES ON PANELS

(71) Applicant: Hewlett-Packard Development Company, L.P., Spring, TX (US)

(72) Inventors: Chung LIN CHEN, Taipei City (TW); Hsiu-Pen LIN, Taipei City (TW); Lien Chia CHIU, Taipei City (TW); KUN CHENG TSAI, Taipei City (TW)

(21) Appl. No.: 17/785,001

(22) PCT Filed: Dec. 13, 2019
(86) PCT No.: PCT/US2019/066253

§ 371 Date: Jun. 13, 2022

(51) Int. Cl. G06F 3/041

(52) U.S. Cl. CPC G06F 3/04164; G06F 3/0412

(57) ABSTRACT

Example implementations relate to electrical traces on panels. In some examples, a display can include an on-cell touch (OCT) panel, a cover panel, and an electrical trace located on the cover panel, where the cover panel is a glass panel and the electrical trace is to transmit a signal from a component to a processor.

### BACKGROUND

A display may be utilized to display information. The information displayed may include text, images, and/or video, among other types of information. Such displays may be utilized in certain computing devices. A computing device can allow a user to utilize computing device operations for work, education, gaming, multimedia, and/or other general use in a static and/or mobile setting.

### BRIEF DESCRIPTION OF THE DRAWINGS

FIG. 1 illustrates a top view of an example of electrical traces on panels consistent with the disclosure.

FIG. 2 illustrates a top view of an example of electrical traces on panels having a border area consistent with the disclosure.

FIG. 3 illustrates a side view of an example of a computing device having electrical traces on panels consistent with the disclosure.

FIG. 4 illustrates a top view of an example of a computing device having electrical traces on panels receiving an input consistent with the disclosure.

### DETAILED DESCRIPTION

A computing device can include a display. A computing device can be, for example, a laptop computer and/or a notebook, a desktop computer, and/or a mobile device (e.g., a smart phone, tablet, personal digital assistant, smart glasses, a wrist-worn device, etc.), among other types of computing devices. The display of the computing device can display information to a user such as text, images, and/or video, among other types of information. As used herein, the term “display” refers to an output device that includes a display area that displays information provided by an electrical signal in a visual and/or tactile form. A display can be, in some examples, a touch-screen display. The display can be integral with the computing device (e.g., a laptop computer/notebook, mobile device, etc.) and/or a peripheral component of a computing device.

Certain computing devices and/or displays may include components. As used herein, the term “component” refers to a part of a system. For example, certain components of computing devices and/or displays can be utilized to receive information and/or inputs. In order to transmit the information to a processing resource, the computing device and/or display can utilize cables. Such cables may be located behind the display area of the display and/or behind a panel of the display and/or computing device in order to hide the cable from view of a user. Ensuring such cables are hidden from view can result in an aesthetically pleasing device.

Utilizing such cables can result in a particular form factor of the computing device and/or display. The physical size of such cables can limit dimensions of the computing device and/or display. For example, such cables can result in a larger sized computing device and/or display. Additionally, the larger size of the computing device and/or display may result in an increase in weight, which can discourage a user from carrying the computing device and/or display in a mobile setting.

Further, during assembly of such a computing device and/or display, these cables are to be connected to the component, routed through the computing device and/or display, and connected to a processor. Such assembly can, in some instances, result in mistakes, which can increase assembly time.

Electrical traces on panels according to the disclosure can utilize electrical traces printed on a display panel of a display. Such electrical traces can be used to transmit information from a component to a processor in lieu of utilizing cables. Use of such electrical traces can, as a result, lead to a smaller form factor of the computing device and/or display, as well as allow for weight savings as compared to a computing device and/or display with cables. Further, the assembly process can be simplified as cables do not have to be routed in the computing device and/or display, leading to a reduction in assembly time.

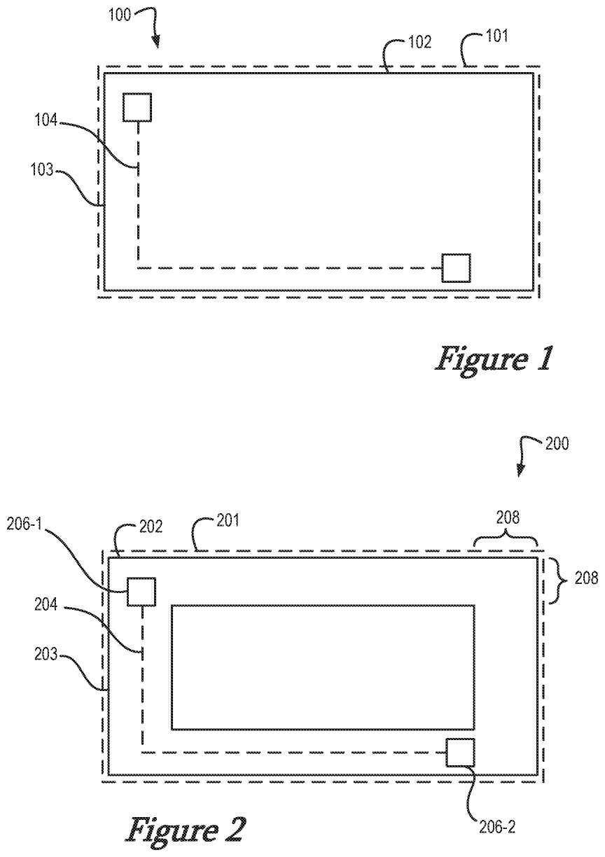

FIG. 1 illustrates a top view of an example of electrical traces 104 on panels consistent with the disclosure. As illustrated in FIG. 1, the display 100 can include an on-cell touch (OCT) panel 101, cover panel 102, edge 103 of the cover panel, and electrical trace 104.

As illustrated in FIG. 1, the display 100 can include an on-cell touch (OCT) panel 101. As used herein, the term “OCT panel” refers to a display panel having touch sensors directly integrated onto the display panel. For example, the OCT panel 101 can include touch sensors directly integrated onto the OCT panel 101. The touch sensors can receive a touch input (e.g., from a user) such that the display 100 can be a touch-screen display.

The OCT panel 101 can be, for example, a display area that displays information provided by an electrical signal in a visual and/or tactile form. For example, the OCT panel 101 can include a display panel that can display information such as text, videos, and/or images, as a result of an electrical signal provided to the display panel. The display panel can be a liquid crystal display (LCD) panel, light emitting diode (LED) panel, active matrix organic light emitting diode (AMOLED) panel, quantum dot (QLED) panel, among other types of display panels.

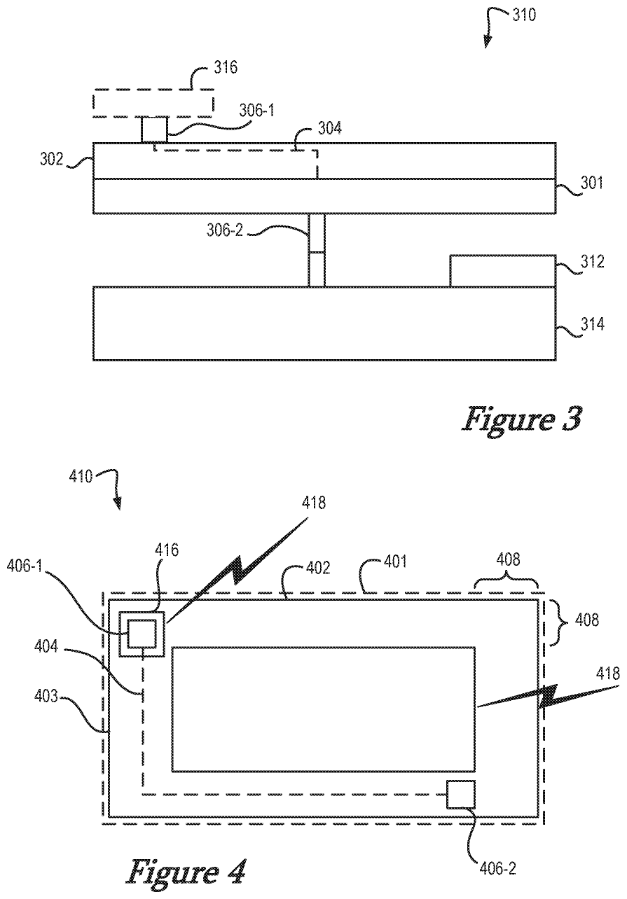

The display 100 can include a cover panel 102. As used herein, the term “cover panel” refers to a panel utilized as a barrier between an outer area of a display and inner components of the display. For example, the cover panel 102 can be a clear glass barrier between an outer area of the display 100 and inner components, such as the OCT panel 101, processor, component, and/or PCBA of the display 100, as is further described in connection with FIGS. 3 and 4. The cover panel 102 can be clear such that objects behind the cover panel 102 can be seen. For example, text, videos, and/or images displayed by the display panel of the OCT panel 101 can be viewed through the cover panel 102. The cover panel 102 can be located adjacent to or substantially adjacent to the OCT panel 101.

As illustrated in FIG. 1, the cover panel 102 can include an electrical trace 104. As used herein, the term “electrical trace” refers to a conductive piece of material to transmit a signal. For example, the electrical trace 104 can be a conductive material located on the cover panel 102.

The electrical trace 104 can be located proximate to an edge 103 of the cover panel 102. For example, the electrical trace 104 can be located near the edge 103 of the cover panel 102 so as to not be visible by a user of the display 100. The electrical trace 104 can be covered by a border area in order to be hidden from view from a user of the display 100, as is further described in connection with FIG. 2.

The electrical trace 104 can be printed on the cover panel 102. For example, the material comprising the electrical trace 104 can be deposited onto the cover panel 102 in order to form the electrical trace 104. In some examples, deposition of the material comprising the electrical trace 104 can occur during manufacturing of the cover panel 102.

The electrical trace 104 can transmit a signal. For example, the conductive electrical trace 104 can transmit a signal from a component (e.g., not illustrated in FIG. 1) to a processor (e.g., not illustrated in FIG. 1). Such use of the electrical trace 104 can allow for the signal to be transmitted from the component to the processor without the use of cables.

FIG. 2 illustrates a top view of an example of electrical traces 204 on panels having a border area 208 consistent with the disclosure. As illustrated in FIG. 2, the display 200 can include an on-cell touch (OCT) panel 201, cover panel 202, edge 203 of the cover panel, and electrical trace 204. The cover panel 202 can include trace terminals 206-1 and 206-2 and a border area 208.

As previously described in connection with FIG. 1, the display 200 can include an OCT panel 201. The OCT panel 201 can include touch sensors directly integrated onto the display panel. As a result, the display 200 can be a touch-screen display.

The display 200 can include cover panel 202. The cover panel 202 can include an electrical trace 204 located on the cover panel 202. The electrical trace 204 can be printed on the cover panel 202.

As illustrated in FIG. 2, the display 200 can include a border area 208. As used herein, the term “border area” refers to an area on a surface that forms an outer boundary of the surface. For example, the border area 208 can be an outer boundary of the cover panel 202.

The border area can be located proximate to the edge 203 of the cover panel 202. For example, the border area 208 can be located near the edge 203 of the cover panel 202. The border area 208 can be located proximate to the edge 203 so as to hide the electrical trace 204. For example, whereas the cover panel 202 can be clear, the border area 208 of the cover panel 202 can be opaque. The opaque border area 208 can hide the printed electrical trace 204 from view of a user of the display 200.

As described above the border area 208 can be opaque. In some examples, the opaque border area 208 can be colored so as to be opaque. In some examples, the opaque border area 208 can be etched, frosted, and/or otherwise treated (e.g., via an application of material to the border area 208 and/or removal of glass material from the border area 208 of the cover panel 202) in such a way so as to render the border area 208 opaque in order to hide the electrical trace 204.

The electrical trace 204 can transmit a signal. For example, the conductive electrical trace 204 can transmit a signal from a component (e.g., not illustrated in FIG. 2) to a processor (e.g., not illustrated in FIG. 2) via trace terminals 206-1, 206-2 connected to the electrical trace 204, as is further described herein.

As illustrated in FIG. 2, the cover panel 202 can include trace terminals 206-1, 206-2. As used herein, the term “trace terminal” refers to a conductive device to act as an interface between an electrical trace and an external circuit. For example, the trace terminals 206-1, 206-2 can be points at which external circuits can be connected to the electrical trace 204. The trace terminals 206-1, 206-2 can be pogo pins and/or other electrical connectors.

The cover panel 202 can include a first trace terminal 206-1 and a second trace terminal 206-2. A component (e.g., not illustrated in FIG. 2) can transmit a signal to the electrical trace 204 via the first trace terminal 206-1. The signal can be transmitted, via the electrical trace 204, to the second trace terminal 206-2. The second trace terminal 206-2 can transmit the signal from the printed electrical trace 204 to an external circuit. The external circuit can be, in some examples, a processor, as is further described in connection with FIG. 3.

FIG. 3 illustrates a side view of an example of a computing device 310 having electrical traces 304 on panels consistent with the disclosure. As illustrated in FIG. 3, the computing device 310 can include an on-cell touch (OCT) panel 301, cover panel 302, electrical trace 304, trace terminals 306-1, 306-2, processor 312, printed circuit board assembly (PCBA) 314, and component 316.

As illustrated in FIG. 3, the computing device 310 can include an OCT panel 301 and a cover panel 302. The cover panel 302 can be located adjacent to or substantially adjacent to the OCT panel 301.

As previously described in connection with FIG. 2, the cover panel 302 can include trace terminals 306-1, 306-2. The first trace terminal 306-1 can be connected to a component 316. The component 316 can transmit a signal to the electrical trace 304 via the first trace terminal 306-1.

The second trace terminal 306-2 can be connected to the processor 312 via the PCBA 314. As used herein, the term “PCBA” refers to a circuit board which electrically connects electronic components using conductive tracks, pads, etc. For example, the PCBA 314 can electrically connect the processor 312 with the second trace terminal 306-2.

The processor 312 can receive the signal from the electrical trace 304 via the second trace terminal 306-2. For example, the signal can be transmitted from the electrical trace 304, through the second trace terminal 306-2 to the PCBA 314, and from the PCBA 314 to the processor 312.

The processor 312 may be a central processing unit (CPU), a semiconductor-based microprocessor, and/or other hardware devices suitable for retrieval and execution of non-transitory machine-readable instructions stored in a memory resource (not illustrated in FIG. 3). The processor 312 may fetch, decode, and execute the stored instructions to perform actions related to electrical traces on panels. As an alternative or in addition to retrieving and executing the stored instructions, the processor 312 may include a plurality of electronic circuits that include electronic components for performing the functionality of the stored instructions to perform actions related to electrical traces on panels.

FIG. 4 illustrates a top view of an example of a computing device 410 having electrical traces 404 on panels receiving an input consistent with the disclosure. As illustrated in FIG. 4, the computing device 410 can include an on-cell touch (OCT) panel 401, cover panel 402, electrical trace 404, trace terminals 406-1, 406-2, border area 408, and component 416.

As previously described in connection with FIG. 3, the computing device 410 can include an OCT panel 401. The OCT panel 401 can include touch sensors directly integrated onto the display panel. As a result, the computing device 410 can include a display which can be a touch-screen display.

The computing device 410 can include cover panel 402. The cover panel 402 can be a glass cover panel such that text, videos, and/or images displayed by the display panel of the OCT panel 401 can be viewed through a clear area of the cover panel 402.

The cover panel 402 can include a border area 408. The border area 408 can be proximate to an edge 403 of the cover panel 402 and can be opaque. The opaque border area 408 can hide the electrical trace 404 from view by a user. The border area 408 can surround the clear area of the cover panel 402.

As illustrated in FIG. 4, the computing device 410 can include a component 416. As used herein, the term “component” refers to a part of a larger system. For example, the component 416 can be a part included in the computing device 410.

The component 416 can be a part of the computing device 410 which can generate a signal. The component 416 can be, for example, an antenna (e.g., a wireless local area network (WLAN) and/or wireless wide area network (WWAN) antenna), a Bluetooth transmitter, a camera, microphone, etc. In other words, the component 416 can be a part which can receive and/or determine information and, in response, generate a signal.

The component 416 can generate the signal in response to an input 418. The input 418 can, in some examples, be an input to the component 416. For example, the input 418 can be an input to an antenna, Bluetooth transmitter, camera, microphone, etc. In some examples, the component 416 can be a sensor (e.g., a light sensor, time of flight sensor, gyroscope, etc.), where the input 418 is received by the sensor. In such an example, the component 416 can generate the signal in response to the input 418 being received by the component 416.

In some examples, the input 418 can be an input received by the cover panel 402. For example, the input 418 can be a touch input (e.g., by a user) that can be received by the cover panel 402. The integrated touch sensors of the OCT panel 401 can, accordingly, generate the signal in response to the touch input being received by the cover panel 402.

When the input is received (e.g., by the component 416 and/or by the cover panel 402/integrated touch sensors of the OCT panel 401), the electrical trace 404 can transmit a signal. For example, the generated signal can be transmitted from the component 416 and/or by the cover panel 402/integrated touch sensors of the OCT panel 401 to the electrical trace 404 via the first trace terminal 406-1, transmitted to the second trace terminal 406-2 via the electrical trace 404, and to a processor (e.g., processor 312, previously described in connection with FIG. 3) of the computing device via the second trace terminal 406-2.

Electrical traces on panels according to the disclosure can allow an electrical trace located on a cover panel to transmit a signal from a component to a processor. Utilizing the electrical trace can allow for a smaller form factor of the display and/or computing device as compared to utilizing cables to transmit a signal. Further, utilizing electrical traces on a cover panel can allow for a simplified assembly process, which can reduce assembly mistakes as well as assembly time.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure.

The figures herein follow a numbering convention in which the first digit corresponds to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2.

Elements illustrated in the various figures herein can be added, exchanged, and/or eliminated so as to provide a plurality of additional examples of the disclosure. In addition, the proportion and the relative scale of the elements provided in the figures are intended to illustrate the examples of the disclosure and should not be taken in a limiting sense. As used herein, “a plurality of” an element and/or feature can refer to more than one of such elements and/or features.

What is claimed:

1. A display, comprising:
an on-cell touch (OCT) panel;
a cover panel; and
an electrical trace located on the cover panel;
wherein the electrical trace is to transmit a signal from a component to a processor.

2. The display of claim 1, wherein the cover panel is a glass panel.

3. The display of claim 1, wherein the electrical trace is printed on the cover panel.

4. The display of claim 1, wherein the display further comprises a border area.

5. The display of claim 4, wherein the electrical trace is hidden by the border area of the display.

6. The display of claim 1, wherein the cover panel includes a trace terminal connected to the electrical trace.

7. The display of claim 6, wherein the trace terminal is to transmit the signal from the trace on the cover panel to the processor.

8. A display, comprising:
an on-cell touch (OCT) panel;
a cover panel; and
a printed electrical trace located on the cover panel;
wherein the printed electrical trace is to transmit a signal from a component to a processor via a trace terminal connected to the printed electrical trace.

9. The display of claim 8, wherein the display further comprises a first trace terminal and a second trace terminal, wherein:
the component is to transmit the signal to the printed electrical trace via the first trace terminal; and
the processor is to receive the signal from the printed electrical trace via the second trace terminal.

10. The display of claim 8, wherein the printed electrical trace is located proximate to an edge of the cover panel.

11. The display of claim 10, wherein the cover panel includes a border area located proximate to the edge of the cover panel to hide the printed electrical trace.

12. A computing device, comprising:
a processor;
a component; and
a display, wherein the display further comprises:
an on-cell touch (OCT) panel;
a cover panel having a clear area and a border area surrounding the clear area; and
a printed electrical trace printed on the cover panel, the printed electrical trace being located on the cover panel such that the printed electrical trace is hidden by the border area;
wherein the printed electrical trace is to transmit a signal from the component of the computing device to a processor of the computing device.

13. The computing device of claim 12, wherein:
the component of the computing device is to generate the signal in response to receiving an input; and
the signal is to be transmitted to the processor of the computing device via the printed electrical trace.

14. The computing device of claim 13, wherein:
the component is a sensor of the computing device; and
the input is received by the sensor.

15. The computing device of claim 13, wherein the input is a touch input received via the cover panel.
